(19) United States
(12) Patent Application Publication
(10) Pub. No.: US 2005/0107069 A1
(43) Pub. Date: May 19, 2005

(54) Method and device for securing messages exchanged in a network

(76) Inventor: Eric Vetillard, Valbonne (FR)

Correspondence Address: William H Eilberg, Suite 501 West, Three Bala Plaza, Bala Cynwyd, PA, 19004, US

(21) Appl. No.: 10/502,309

(22) PCT Filed: Jan. 31, 2003
(86) PCT No.: PCT/FR03/00288

(30) Foreign Application Priority Data
Feb. 1, 2002 (FR) 02/01435

(51) Int. Cl. H04M 3/16

(52) U.S. Cl. 455/410

(57) ABSTRACT

In order to secure messages that are exchanged in a data transmission network between a server (1) and a client (2), a control device that is decentralized or represents the authority (3) is permanently inserted into the network between the server (1) and the user (2) during the secured exchange of messages. The representative of the authority (3) translated the transmitted messages and carries out the message verifications that have been decided by the authority. The representative of the authority (3) can be a specific microprocessor card, for example, which is permanently inserted between the server (1) and the client (2), so that the authority does not need to be directly involved in the transactions and no permanent connection with the authority is required.

### TECHNICAL FIELD OF THE INVENTION

The present invention relates to information systems including a data transmission network in which a server and a client communicate via the network under the control of an authority that draws up communication rules.

Effective control of communication by the authority necessitates continuous direct contact with the authority, which requires a continuous remote connection.

Effective control of communication by the authority is often difficult to achieve, especially if the authority may not be contacted directly, if the authority does not wish to be directly involved in a transaction, or if the client and the server are not able to enter into direct contact.

### STATEMENT OF THE INVENTION

The problem addressed by the invention is that of designing a new network information system architecture in which an authority can exercise control without this necessitating a permanent connection with the authority.

At the same time it is necessary to ensure that control is effected continuously, so that transmissions are secured correctly.

The basic idea of the invention is to ensure effective and continuous control of communication by a representative of the authority that is implemented in or in the immediate vicinity of the client, with the result that the invention may be applied to architectures in which the client is small and does not itself have the necessary resources for executing the security functions and other functions of the representative of the authority.

To achieve the above and other objects, the invention provides a method of securing messages exchanged over a data transmission network between a server and a client, under the control of an authority that defines message exchange rules ; according to the invention, control is provided in a decentralized manner by a representative of the authority, inserted permanently into the network between the server and the client, in the vicinity of the client, during the secure exchange of messages, to translate transmitted messages and to apply verifications decided on by the authority to transmitted messages.

In one advantageous embodiment, a first protocol is used for exchanges between the server and the representative of the authority, and a second protocol different from the first protocol is used for exchanges between the representative of the authority and the client.

In practice, for the exchange of messages in accordance with the invention:

a first secure channel is set up between the server and the representative of the authority, using a first key known to the representative of the authority and to the server but not to the client, and using a first encryption algorithm, and

a second secure channel is set up between the representative of the authority and the client, using a second key known to the representative of the authority and to the client but not to the server, and using a second encryption algorithm.

The invention also provides a device for securing messages exchanged over a data transmission network between a server and a client under the control of an authority that defines message exchange rules; according to the invention, provision is made for a decentralized control device or representative of the authority inserted permanently into the network between the server and the client, in the vicinity of the client, during the secure exchange of messages to translate transmitted messages and to apply verifications decided on by the authority to transmitted messages.

In an advantageous embodiment, the decentralized control device or representative of the authority is a data processing microsystem secured by hardware, inserted permanently between the server and the client during the exchange of messages.

It is advantageous to provide that:

the server is a data processing system comprising an input-output port;

the client is a data processing microsystem comprising an input-output port;

the representative of the authority is a data processing microsystem secured by hardware and comprising an interface device;

a dedicated interface system is provided, comprising an input-output port connected to the input-output port of the server data processing system, a card port connected to the input-output port of the client data processing microsystem, an input-output port connected to the interface device of the representative of the authority data processing microsystem, and a controller programmed to control communication between the input-output ports;

the controller and the representative of the authority are programmed so that:

the server data processing system sends a request A to the client data processing microsystem, and that request is received by the controller;

the controller transmits the request A to the representative of the authority, which sends it back a response Ra;

the controller uses that response Ra to calculate a request A′ that is sent to the client data processing microsystem;

the client data processing microsystem processes the request A′ to prepare a response B′;

the client data processing microsystem sends the response B′ to the server data processing system; that response is received by the controller

the controller transmits the response B′ to the representative of the authority, which sends it back a response Rb;

the controller uses that response Rb to calculate a response B that is sent to the server data processing system.

In a first application, it can be provided that:

the client is a smart card;

the representative of the authority is a smart card;

the dedicated interface system is a smart card reader comprising two card ports.

In a second application, it can be provided that:

the client is a mobile communication system;

the server is a data processing system communicating with the client via a physical connection or via a wireless communication network;

the representative of the authority is a smart card representing the operator of the wireless communication network (known as the SIM card in telephones conforming to the GSM standard).

In a third application, it can be provided that

the client is a smart card;

the representative of the authority is a data processing system secured by hardware;

the dedicated interface system is a machine comprising a card port and a dedicated input-output interface for connection to the representative of the authority data processing system.

### BRIEF DESCRIPTION OF THE DRAWINGS

Other objects, features and advantages of the present invention will emerge from the following description of particular embodiments of the invention with reference to the appended drawings, in which:

FIG. 1 represents diagrammatically the exchange of messages between a server and a client in accordance with the general solution of the present invention;

FIG. 2 represents the exchange of messages between a server and a client, in an executable code downloading application;

FIG. 3 represents the transmission of messages from a server to a client in a public key cryptography application;

FIG. 4 represents an embodiment of the invention in which the server is a data processing system, and the client is a smart card connected to the data processing system via a smart card reader;

FIG. 5 represents an embodiment of the kind shown in FIG. 4, and in which the representative of the authority is implemented in another smart card connected to the same smart card reader;

FIG. 6 represents the data stream of a request sent from a server to a client in the FIG. 5 embodiment; and

FIG. 7 represents the data stream of a response sent from the client to the server in the FIG. 5 embodiment.

### DESCRIPTION OF THE PREFERRED EMBODIMENTS

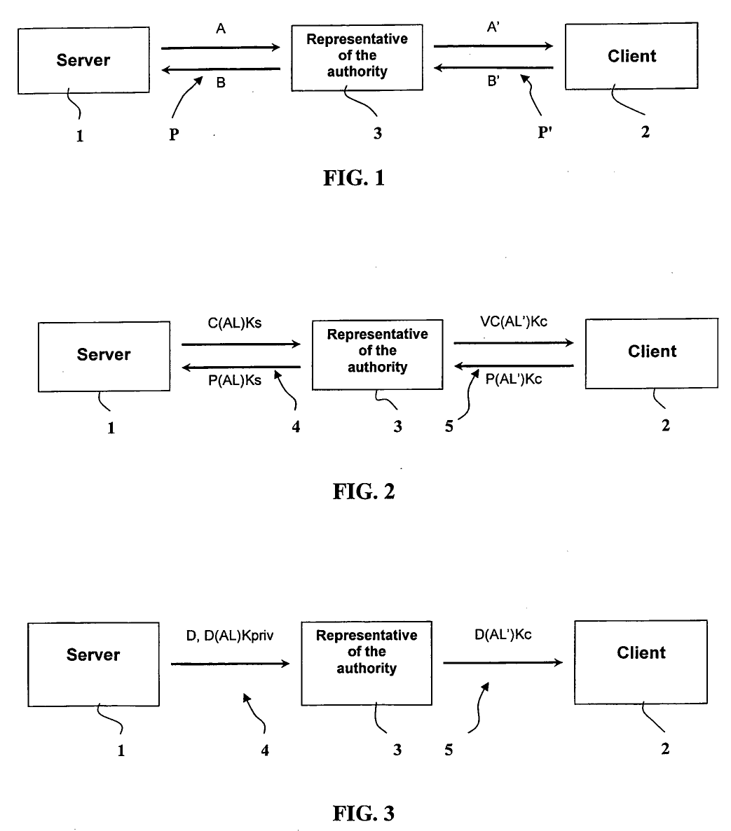

As shown in FIG. 1, a device for securing messages exchanged over a data transmission network between a server 1 and a client 2, under the control of an authority which defines message exchange rules, generally comprises a decentralized control device, consisting of a representative 3 of the authority inserted permanently into the network between the server 1 and the client 2 during the secure exchange of messages.

The representative 3 of the authority translates messages and carries out actions decided on by the authority.

From the protocol point of view, the representative 3 of the authority is entirely transparent, in the sense that the server 1 communicates with it and with one of its clients, and the client 2 communicates with it as with a server.

On the other hand, this makes it possible to use different protocols, namely a first protocol P between the server 1 and the representative 3 of the authority, and a second protocol P′ between the representative 3 of the authority and the client 2. A message A transmitted by the server 1 is converted by the representative 3 of the authority into a message A′ received by the client 2. In return, a response message B′ sent by the client 2 is converted by the representative 3 of the authority into a message B received via the server 1.

The representative 3 of the authority constitutes a decentralized control device and may advantageously be in the vicinity of the client 2.

An advantageous solution is to implement the representative 3 of the authority in a dedicated smart card, inserted permanently between the server 1 and the client 2 during the secure exchange of messages.

The representative 3 of the authority holds secrets belonging to the authority, which ensure that communication between the server 1 and the client 2 may be established only under its control. A cryptographic protocol may advantageously be used to ensure the use of the representative 3 of the authority.

If the representative 3 of the authority is implemented in a smart card, this ensures that the secrets held by the representative 3 of the authority are protected from external attack.

A first example of use of the invention to verify an executable code to be downloaded into the client 2 is described next. This application is described with reference to FIG. 2.

In certain circumstances a server 1 may be called upon to download an executable code into a client 2. However, that code must conform to a set of properties that must be verified by a verification authority before downloading is authorized. These verifications are intended to ensure the security of the client, and are therefore generally under the responsibility of the proprietor of the client.

The invention addresses the situation in which the client 2 is a data processing microsystem such as a smart card or some other onboard system with limited security capabilities, for example a cellular telephone or a personal digital assistant. Programs must be loaded via a secure channel between the server and the client, which channel guarantees the integrity and/or the confidentiality of information transmitted over the channel. Setting up this channel necessitates the existence of a cryptographic secret (key K) shared by the client 2 and the server 1.

According to the invention, a dedicated smart card which represents the verification authority and constitutes the representative 3 of the authority may be used. The smart card is inserted between the server 1 and the client 2. The representative 3 of the authority may then effect all the necessary verifications. It sets up two secure channels for exchanging messages:

a first secure channel 4, between the server 1 and the representative 3 of the authority, using a first key Ks known to the representative 3 of the authority and to the server 1 but not to the client 2, and using a first encryption algorithm AL, and

a second secure channel 5, between the representative 3 of the authority and the client 2, using a second key Kc known to the representative 3 of the authority and to the client 2 but not to the server 1, and using a second encryption algorithm AL′.

This ensures that communication may be set up between the client 2 and the server 1 only via the representative 3 of the authority, and thus ensures that the necessary verifications are effected.

Code may then be loaded in the following manner

the server 1 sets up a first secure channel 4 with the representative 3 of the authority, using the key Ks and the algorithm AL;

the server 1 sends the code C to be loaded to the representative 3 of the authority, via the first secure channel 4; the notation C(AL)Ks in FIG. 2 indicates that the code C is secured by the algorithm AL and the key Ks (signature and/or encryption);

the representative 3 of the authority verifies the properties on the code C; the notation VC indicates the code verified in this way, to which may be added a proof that the verification has been effected;

the representative 3 of the authority sets up a second secure channel 5 with the client 2, using the key Kc and the algorithm AL′;

the representative 3 of the authority sends the verified code VC to the client 2 using the second secure channel 5 as previously set; it therefore transmits VC(AL′)Kc; and

if necessary, the client 2 sends a proof P of loading via the second secure channel 5: it therefore sends P(AL′)Kc; to communicate with the server 1, the representative 3 of the authority then translates this message using P(AL)Ks.

This solution has numerous advantages: verification may be effected systematically, without necessitating direct communication with the verification authority; and verification may be effected without necessarily making any change of client or server: for the server 1, the representative 3 of the authority behaves as a client; for the client 2, the representative 3 of the authority behaves as a server.

What is more, the solution of the invention does not necessitate any additional resources in the client 2 to effect the verification. Neither does it necessitate the client 2 to be in a position to verify electronic signatures. Equally, the solution is very flexible. Finally, this solution enables implementation in a smart card, and may therefore be used in non-connected environments.

A second example of an application of the invention to public key cryptography is described next.

Certain cryptographic protocols used with smart cards are based on the use of public key cryptography. However, these cryptographic techniques are costly, and for this reason are not supported by all smart cards.

One particularly beneficial situation is verifying electronic signatures for guaranteeing the source of downloaded data, for example. The electronic signatures generally use public key algorithms. However, this is a problem for the simplest smart cards and other simple systems, because of the considerable resources necessary for using the algorithm. These algorithms are based on a pair of keys (Kpriv, Kpub). The key Kpriv is used by the server 1 to calculate the signature of the data, and must be known only to the server 1. The key Kpub is used by the client 2 to verify the signature of the data, and may be circulated with no confidentiality constraints.

According to the invention, a representative 3 of the control authority of the client 2 is inserted between the server 1 that sends the electronically signed data and the client 2 that receives the data and verifies the electronic signature. This representative 3 of the authority is responsible for verifying the electronic signature in the name of the client 2 and then communicating the data to him via a channel secured by a key Kc, known only to the representative 3 of the authority and the client 2.

FIG. 3 depicts the communication process

the server 1 calculates the signature of the data D using the key Kpriv and the algorithm AL; the result is D(AL)Kpriv;

the server 1 communicates the data D and the signature to the representative 3 of the authority, where applicable via a first secure channel 4;

the representative 3 of the authority verifies the signature and the data D;

the representative 3 of the authority sets up a second secure channel 5 with the client 2 using the key Kc and the algorithm AL′; and

the representative 3 of the authority transmits the data D to the client 2 via the second secure channel 5 in the form D(AL′)Kc, without a signature.

In contrast to the preceding first example, the representative 3 of the authority is not entirely transparent, in the sense that the protocol used between the server 1 and the representative 3 of the authority differs from the protocol used between the representative 3 of the authority and the client 2. This solution may be used in other situations in which protocol translations are necessary.

In the above examples, the use of a representative 3 of the authority is rendered transparent for the server 1 and for the client 2 from a logical point of view, but messages must nevertheless be physically routed to the representative 3 of the authority instead of being routed to the client 2. It is therefore necessary for the server 1 to be programmed to communicate with the representative 3 of the authority, and not to communicate with the client 2.

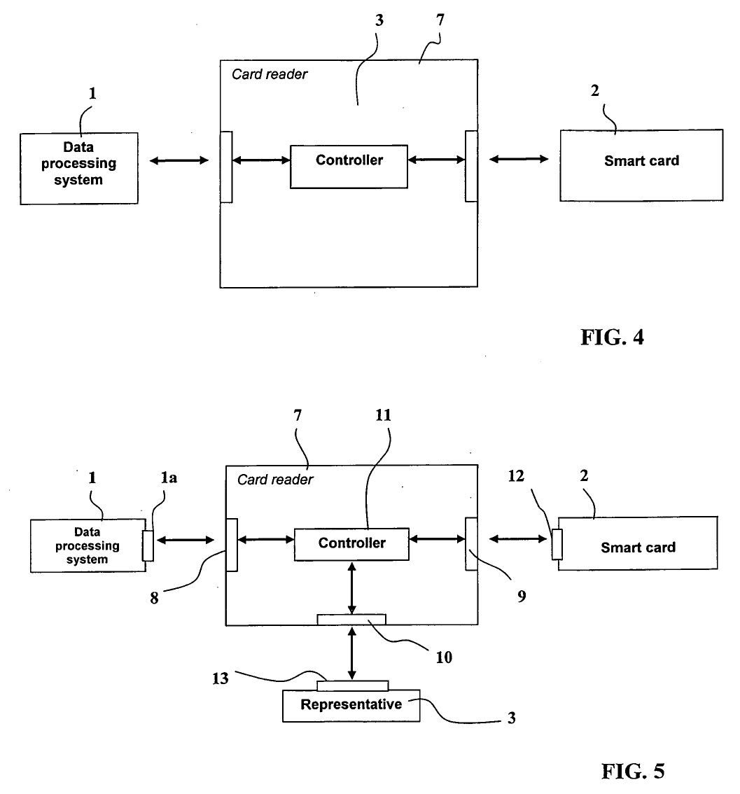

For example, if the server 1 is conventionally programmed to communicate directly with the client 2, and if the server 1 is a data processing system and the client 2 is a smart card, the invention proposes to integrate the representative 3 of the authority mechanism, either permanently into a smart card reader 7 connecting the server data processing system 1 to the client card 2, as shown in FIG. 4, or removably into a separate smart card connected to the smart card reader 7, as shown in FIG. 5. In this FIG. 5 embodiment, the server data processing system 1 comprises an input-output port 1a. The server data processing system 1 is associated with the smart card reader 7, which has an input-output port 8 connected to the input-output port 1a of the server data processing system 1. The smart card reader 7 comprises a card port 10 adapted to connect a smart card 3 representing the authority, and a card port 9 adapted to connect a smart card 2, which is the client in this embodiment. The smart card 2 comprises an input-output port 12 connected to the card port 9. The smart card reader 7 also comprises a controller 11 programmed to control communication between the input-output port 8, the card port 10 and the card port 9.

The smart card 3 connected to the card port 10 therefore defines a representative of the authority.

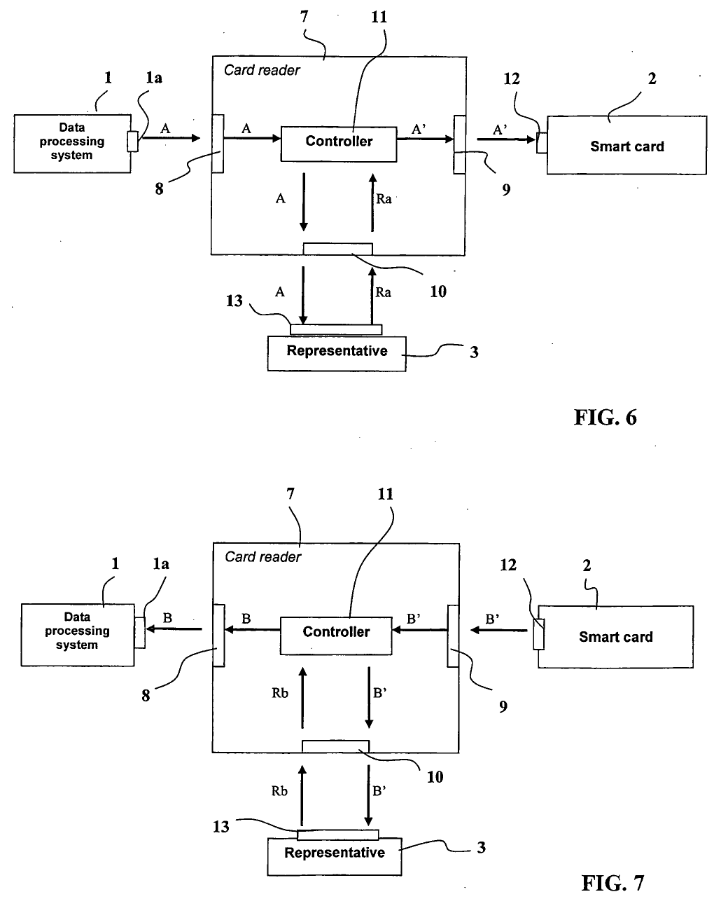

The controller 11 and the smart card 3 (the representative of the authority) are programmed so that the data streams are as depicted in FIG. 6 for a request sent from the server data processing system 1 to the client smart card 2, and as depicted in FIG. 7 for a response returned from the client smart card 2 to the server data processing system 1.

For the data stream of the request sent from the server data processing system 1 to the client smart card 2 (FIG. 6):

the server data processing system 1 sends a request A to the client smart card 2; this request is received by the controller 11;

the controller 11 transmits the request A to the representative 3 of the authority, which sends it back a response Ra; and

the controller 11 uses that response Ra to calculate a request A′ that is sent to the client smart card 2.

The return data stream sent by the client smart card 2 to the server data processing system 1 is as follows (FIG. 7):

the client smart card 2 sends a response B′ to the server data processing system 1. This response is received by the controller 11;

the controller 11 transmits the response B′ to the representative 3 of the authority, which sends it back a response Rb; and

the controller 11 uses that response Rb to calculate a response B that it sends to the server data processing system 1.

In the simplest case, the responses Ra and Rb may simply be an encapsulation of the translated messages A and B′.

FIGS. 5 to 7 may also serve to illustrate an embodiment in which the representative 3 of the authority is a data processing microsystem secured by hardware comprising an interface device 13. The input-output port 10 of the interface system 7 is then connected to the interface device 13.

The present invention is not limited to the embodiments that have been explicitly described, and encompasses variants and generalizations thereof within the scope of the following claims.

1. Method of securing messages exchanged over a data transmission network between a server (1) and a small client (2) that does not have the resources necessary for providing security functions, under the control of an authority that defines message exchange rules, wherein control is provided in a decentralized manner by a representative (3) of the authority, inserted permanently into the network in the vicinity of the client (2) and between the server (1) and the client (2) during the secure exchange of messages, to translate transmitted messages and to apply verifications decided on by the authority to transmitted messages:

2. Method according to claim 1, wherein a first protocol (P) is used for exchanges between the server (1) and the representative (3) of the authority, and a second protocol (P′) different from the first protocol (P) is used for exchanges between the representative (3) of the authority and the client (2).

3. Method according to claim 1, wherein, for the exchange of messages:
a first secure channel (4) is set up between the server (1) and the representative (3) of the authority, using a first key (Ks) known to the representative (3) of the authority and to the server (1) but not to the client (2), and using a first encryption algorithm (AL), and
a second secure channel (5) is set up between the representative (3) of the authority and the client (2), using a second key (Kc) known to the representative (3) of the authority and to the client (2) but not to the server (1), and using a second encryption algorithm (AL′).

4. Device for securing messages exchanged over a data transmission network between a server (1) and a small client (2) that does not have the resources necessary for providing the security function, under the control of an authority that defines message exchange rules, comprising a decentralized control device or representative (3) of the authority, inserted permanently into the network in the vicinity of the client (2) and between the server (1) and the client (2) during the secure exchange of messages, to translate transmitted messages, and to apply verifications decided on by the authority to transmitted messages.

5. Device according to claim 4, wherein the decentralized control device or representative (3) of the authority is a data processing microsystem secured by hardware, inserted permanently between the server (1) and the client (2) during the exchange of messages.

6. Device according to claim 5, wherein:
the server (1) is a data processing system comprising an input-output port (1a);
the client (2) is a data processing microsystem comprising an input-output port (12);
the representative (3) of the authority is a data processing microsystem secured by hardware and comprising an interface device (13);
a dedicated interface system (7) is provided, comprising an input-output port (8) connected to the input-output port (1a) of the server data processing system (1), comprising a card port (9) connected to the input-output port (12) of the client data processing microsystem (2), comprising an input-output port (10) connected to the interface device (13) of the representative (3) of the authority data processing microsystem, and comprising a controller (11) programmed to control communication between the input-output ports (8), (9) and (10);
the controller (11) and the representative (3) of the authority are programmed so that:
the server data processing system (1) sends a request A to the client data processing microsystem (2), and that request is received by the controller (11);
the controller (11) transmits the request A to the representative (3) of the authority, which sends it back a response Ra;
the controller (11) uses that response Ra to calculate a request A′ that is sent to the client data processing microsystem (2);
the client data processing microsystem (2) processes the request A′ to prepare a response B′;
the client data processing microsystem (2) sends the response B′ to the server data processing system (1); that response is received by the controller (11);
the controller (11) transmits the response B′ to the representative (3) of the authority, which sends it back a response Rb;
the controller (11) uses that response Rb to calculate a response B that is sent to the server data processing system (1).

7. Device according to claim 6, wherein:
the client (2) is a smart card;
the representative (3) of the authority is a smart card;
the dedicated interface system is a smart card reader (7) comprising two card ports (9) and (10).

8. Device according to claim 6, wherein:
the client (2) is a mobile communication system;
the server (1) is a data processing system communicating with the client (2) via a physical connection or via a wireless communication network;
the representative (3) of the authority is a smart card representing the operator of the wireless communication network (known as the SIM card in telephones conforming to the GSM standard).

9. Device according to claim 6, wherein:
the client (2) is a smart card;
the representative (3) of the authority is a data processing system secured by hardware;
the dedicated interface system (7) is a machine comprising a card port (9) and a dedicated input-output interface (10) for connection to the representative (3) of the authority data processing system.
